(19) United States
(12) Patent Application Publication
(10) Pub. No.: US 2008/0204910 A1
(43) Pub. Date: Aug. 28, 2008

(54) LENS MODULE

(75) Inventor: TSUNG-WEI CHIANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/847,291

(22) Filed: Aug. 29, 2007

(30) Foreign Application Priority Data
Feb. 27, 2007 (CN) 200710200232.1

(51) Int. Cl. G02B 7/02

(52) U.S. Cl. 359/830; 359/819

(57) ABSTRACT

An exemplary lens module includes a barrel, a metallic spacer, and a glass lens. The metallic spacer is disposed in the barrel. The metallic spacer has a through hole defined therein. The glass lens is received in the through hole of the metallic spacer.

### BACKGROUND

1. Technical Field

The present invention relates to the optical imaging field and, particularly, to a lens module.

2. Description of Related Art

With the development of the optical imaging technology, lens modules are widely used in electronic devices, such as digital camera, and mobile phones.

Referring to FIG. 5, a typical lens module 200 includes a plastic barrel 202, a glass lens 204, a first lens 206, a second lens 208, an infrared-cut filter 214, and spacers 210, 212.

However, when the glass lens 204 is assembled into the plastic barrel 202, the plastic barrel 202 may be deformed easily because a hardness difference between the glass lens 204 and the plastic barrel 202 is usually large. Furthermore, it is difficult to perpendicularly insert the glass lens 204 into the plastic barrel 202. Therefore, the glass lens 204 is prone to be slanted when placed in the lens module 200 (see FIG. 6). Accordingly, imaging quality of the lens module 200 is deteriorated, and such a lens module 200 is unsatisfactory.

It is therefore desirable to find a new lens module, which can overcome the above mentioned problems.

### SUMMARY

An exemplary lens module includes a barrel, a metallic spacer, and a glass lens. The metallic spacer is disposed in the barrel. The metallic spacer has a through hole defined therein. The glass lens is received in the through hole of the metallic spacer.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, side cross-sectional view of a lens module according to a present embodiment;

FIG. 2 is a schematic, plan view of a spacer in the lens module of FIG. 1;

FIG. 3 is a schematic, side cross-sectional view of the lens module of FIG. 1 in a second state when a glass lens is totally received in a spacer;

FIG. 4 is a schematic, side cross-sectional view of the lens module of FIG. 1 in a third state after the glass lens is moved along an optical axis;

FIG. 5 is a schematic, side cross-sectional view of a typical lens module; and

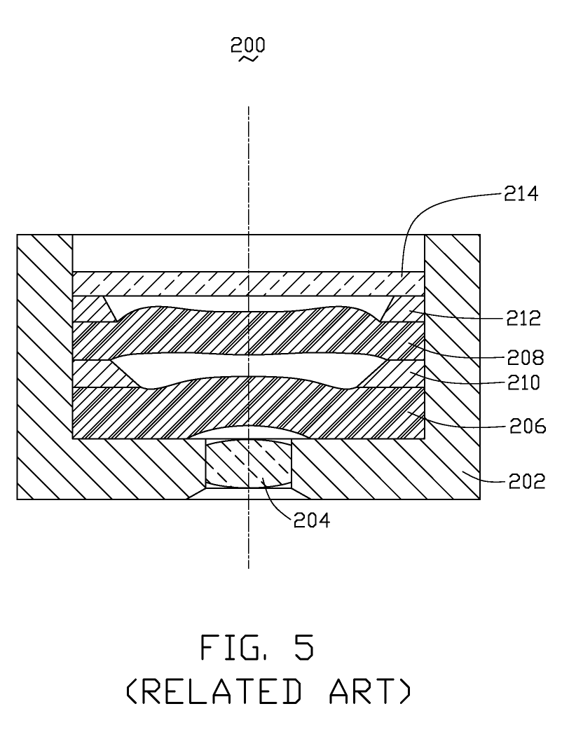

FIG. 6 is a schematic, side cross-sectional view of the lens module of FIG. 5 when the glass lens leans.

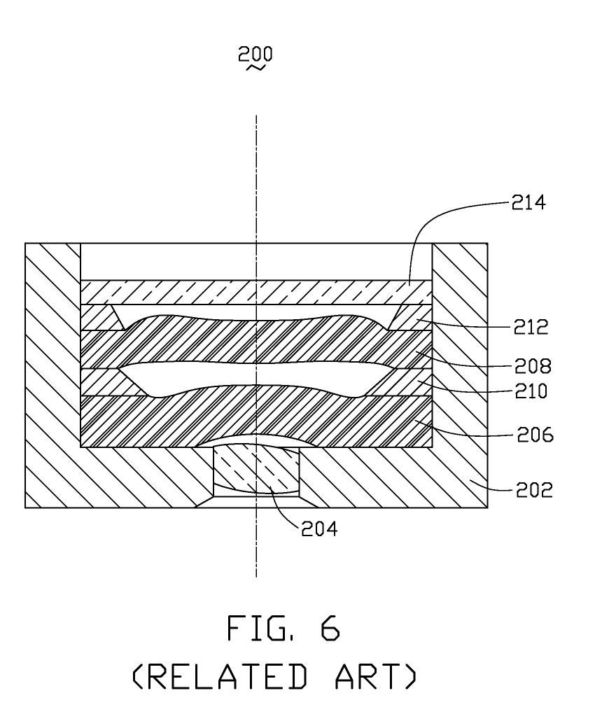

### DETAILED DESCRIPTION OF THE EMBODIMENTS

Embodiments will now be described in detail below with reference to the drawings.

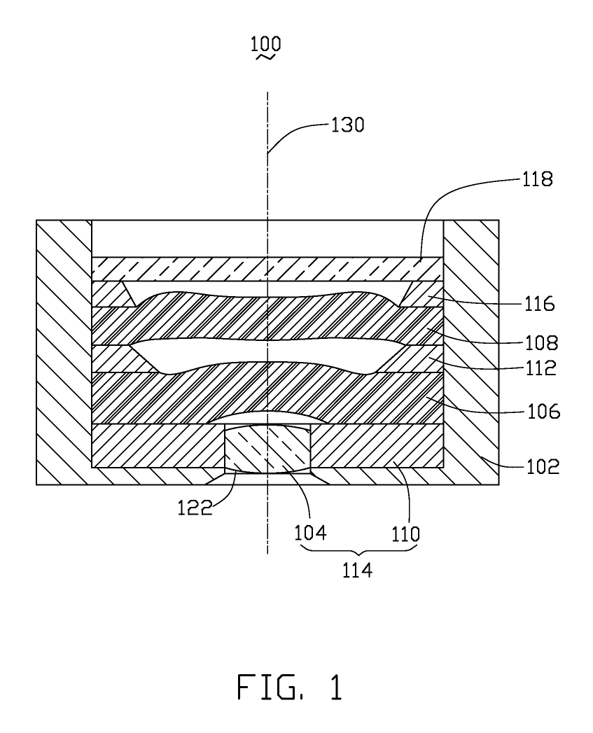

Referring to FIG. 1, a lens module 100 of an exemplary embodiment is shown. The lens module 100 includes a barrel 102 and a plurality of optical elements disposed in the barrel 102. The plurality of optical elements include a glass lens 104, lenses 106 and 108, an infrared-cut filter 118, and spacers 110, 112 and 116.

The spacer 110 is made of metallic material. The metallic material includes metals and metal alloys. The metallic material can be, for example, iron, iron alloy (e.g., steel), aluminium, aluminium alloy, copper, or copper alloy. The aluminium and aluminium alloy can be treated using anode oxidation technology, thereby increasing hardness. A hardness of the metallic material can be close to that of the glass lens 104. For example, when a Mohs hardness of the glass lens 104 is H_{M}, a Mohs hardness of the metallic material can be in an approximate range from (H_{M}−1) to (H_{M}+1). That is, when a Mohs hardness of the glass lens 104 is in an approximate range from 5 to 6, a Mohs hardness of the metallic material can be in an approximate range from 4 to 7. In this case, the metallic material can be iron, a Mohs hardness of which is in an approximate range from 3.5 to 4.5.

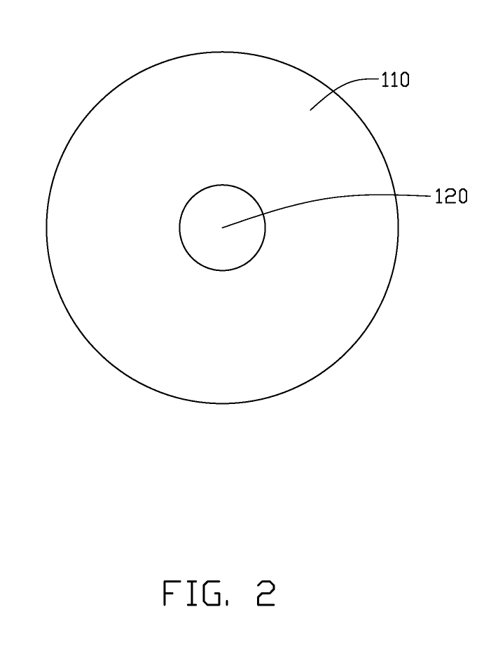

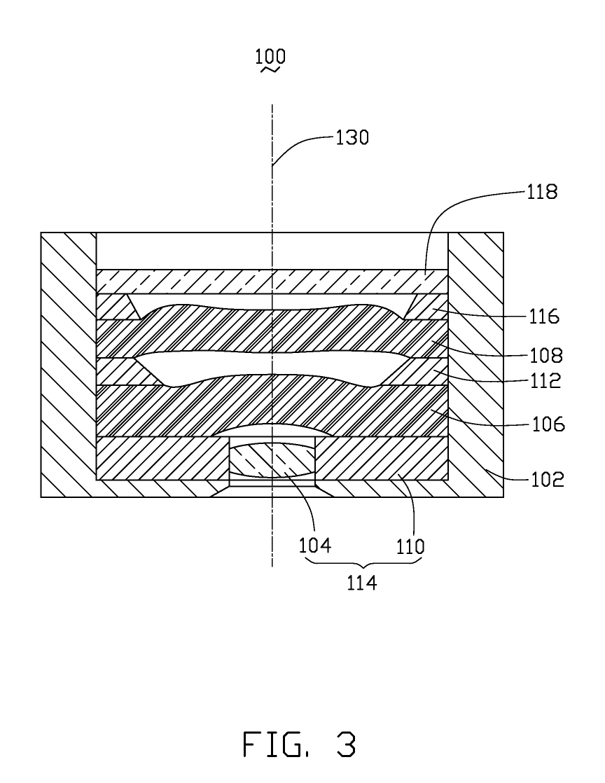

Referring to FIG. 2, the spacer 110 can be a ring with a through hole 120 defined therein. The through hole 120 is configured for accommodating the glass lens 104. The through hole 120 has a shape corresponding to a shape of the glass lens 104 in plan view. The through hole 120 can be circular, elliptic, or square in plan view depending on the shape of the glass lens 104. In the present embodiment, part of the glass lens 104 is received in the spacer 110 (see FIG. 1). Alternatively, the glass lens 104 could be totally received in the spacer 110 (see FIG. 3). A central axis of the through hole 120 can be coincident with an optical axis 130 of the glass lens 104.

The barrel 102 can be made of plastic. The lenses 106 and 108 can be made of glass or plastic. The spacer 112 is configured for keeping a constant distance between the lens 106 and the lens 108. The spacer 116 is configured for keeping a constant distance between the lens 108 and the infrared-cut filter 118.

Referring to FIG. 1 again, a method for making the lens module 100 including the steps of:

1) placing the glass lens 104 into the through hole of the spacer 110, thus forming a lens unit 114, wherein the spacer is made of metallic material; and
2) positioning the lens unit 114, the lens 106, the spacer 112, the lens 108, the spacer 116, and the infrared-cut filter in this order from an object side to an image side into the barrel 102, thus obtaining the lens module 100.

In the above method, after the glass lens 104 is assembled into the spacer 110, a centering error of the lens unit 114 can be measured. Some lens units 114 may be unsatisfactory because of unacceptably large centering errors. In this case, the optical axis 130 of the lens unit 114 can be adjusted by slightly changing a position of the glass lens 104, thus reducing or eliminating the centering error of the lens unit 114.

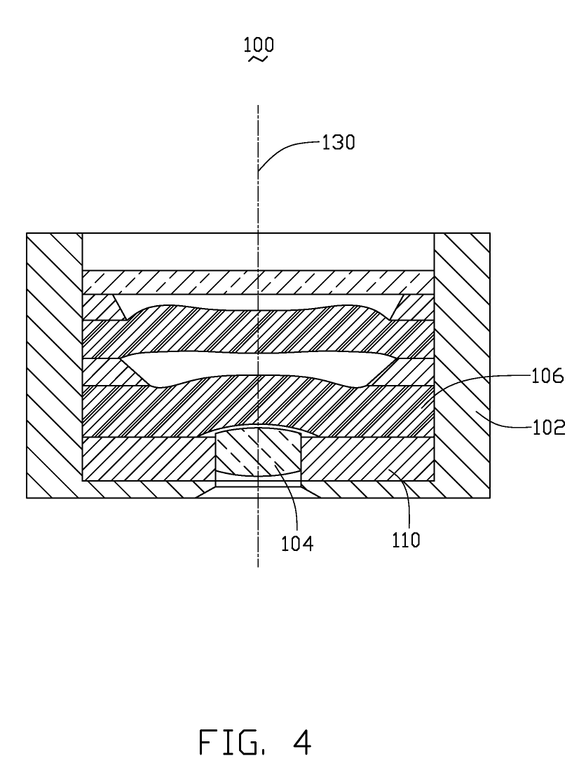

In addition, the glass lens 104 can be moved along the optical axis 130 of the lens module 100, thus adjusting a distance relative to the other lenses (e.g., lens 106), referring to FIG. 4.

In the above mentioned embodiment, the glass lens 104 is received in the spacer 110. The spacer 110 is made of metallic material and has a high level of hardness. As a result, the spacer 110 does not deform easily. Moreover, it is easy to assemble the glass lens 104 into the spacer 110. Thus, slanting of the glass lens 104 can be avoided after the glass lens 104 is placed into the spacer 110. Therefore, imaging quality of the lens module 100 is improved.

In addition, the spacer 110 can be made of metallic material and with a high level of precision. Therefore, the glass lens 104 couples well with the spacer 110. In this way, the slanting of the glass lens 104 is further avoided.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A lens module comprising:
a barrel;
a metallic spacer disposed in the barrel, the spacer having a through hole defined therein; and
a glass lens received in the through hole of the metallic spacer.

2. The lens module as claimed in claim 1, wherein a Mohs hardness of the glass lens is H_{M}, and a Mohs hardness of the metallic spacer is in an approximate range from (H_{M}−1) to (H_{M}+1).

3. The lens module as claimed in claim 1, wherein a Mohs hardness of the metallic spacer is in an approximate range from 4 to 7.

4. The lens module as claimed in claim 1, wherein the metallic spacer is comprised of a material selected from the group consisting of iron, iron alloy, aluminium, aluminium alloy, copper, and copper alloy.

5. The lens module as claimed in claim 1, wherein the metallic spacer is ring-shaped.

6. The lens module as claimed in claim 1, wherein a central axis of the through hole is coincident with an optical axis of the glass lens.

7. A method for making a lens module, comprising:
placing a glass lens into a through hole of a metallic spacer, thus forming a lens unit; and
disposing the lens unit into the barrel.

8. The method as claimed in claim 7, wherein a Mohs hardness of the glass lens is H_{M}, and a Mohs hardness of the metallic spacer is in an approximate range from (H_{M}−1) to (H_{M}+1).

9. The method as claimed in claim 7, wherein a Mohs hardness of the metallic spacer is in an approximate range from 4 to 7.

10. The method as claimed in claim 7, wherein the metallic spacer is comprised of a material selected from the group consisting of iron, iron alloy, aluminium, aluminium alloy, copper, and copper alloy.
